(19) United States
(12) Patent Application Publication
(10) Pub. No.: US 2016/0094095 A1
(43) Pub. Date: Mar. 31, 2016

(54) ROTATING ARMS TYPE PERMANENT MAGNET MOTOR

(71) Applicant: Hsiuping University of Science and Technology, Taichung City (TW)

(72) Inventor: Chih-Chiang HONG, Taichung City (TW)

(21) Appl. No.: 14/526,919

(22) Filed: Oct. 29, 2014

(30) Foreign Application Priority Data
Sep. 25, 2014 (TW) 103133321

(51) Int. Cl. H02K 1/17; H02K 1/27

(52) U.S. Cl. CPC H02K 1/17; H02K 1/27; Y10S 74/09; H02K 53/00

(57) ABSTRACT

A rotating arms type permanent magnet motor is actuated by the action of magnetic forces of a permanent magnet stator of a stator module and two thin ring permanent magnets of a rotor module. Since the thin ring permanent magnet installed at a double arc shaped rotating arms type support frame is installed with opposite polarities, therefore the thin ring permanent magnet of the rotor module produces magnetic repulsion and attraction with respect to the permanent magnet stator of the stator module while the elastic metal plate cantilever arm of the stator module is being swung elastically to maintain the rotation and operation of the rotating arms type support frame mounted onto a rotating shaft and drive a motor to rotate stably and regularly by a torque produced by a magnetic force. Without using any external power supply and fuel, the motor saves electricity and power sources.

The current application claims a foreign priority to the patent application of Taiwan No. 103133321 filed on Sep. 25, 2014.

### FIELD OF THE INVENTION

The present invention relates to a rotating arms type permanent magnet motor, in particular to a permanent magnet motor that uses the torque produced by a magnetic force of the magnetic energy of a stator to drive the rotation of the rotor.

### BACKGROUND OF THE INVENTION

At present, conventional actuators are applied extensively in different fields, and the actuators primarily use pneumatic or hydraulic pressure as power to drive the actuators to perform a linear movement, and the actuators of this sort are mainly applied in the automatic control machinery related fields. A pneumatic or hydraulic cylinder is provided for actuating and moving an object or applying a pressure to fix the object. However, the efficiency of a compressor that uses pneumatic or hydraulic pressure as power is relatively lower. Compared with a power source that uses pneumatic or hydraulic pressure as power, the power source that uses electricity as power has lower power consumption. Therefore, electric actuators have been applied even more extensively in various fields, and electric motors have replaced the pneumatic cylinder, and the rotation of the electric motor is converted into a linear movement to move an output shaft reciprocally.

As science and technology advance, equipments tends to be developed with a thin, light, short and compact design, and various types of driving devices of thin 3C products such as micro-motors and micro-fans require basic functions including low noise, high power, good thermal dissipation and precise positioning capability. Recently, driving devices are applied in piezoelectric actuators, and these driving devices have the advantages and features of low voltage, anti-noise, small volume, quick response, low heat generation, high precision, high conversion rate, easy control, etc. The operating principle of a piezoelectric actuator is to generate energy wave by inputting electric energy and drive a metal disc of the piezoelectric actuator to have a deformation, so as to produce an actuation force.

The types and applications of actuators are described above, and each type of actuators has its scope of applicability, advantages and disadvantage. Therefore, the inventor of the present invention based on years of experience in the related industry to design and develop a novel actuator that uses the principle of magnetism to provide better applications and effects.

### SUMMARY OF THE INVENTION

In view of the problems of the conventional actuators including the low operating efficiency and limited function, it is a primary objective of the present invention to provide a rotating arms type permanent magnet motor to overcome these problems.

To achieve the aforementioned objective, the present invention provides a rotating arms type permanent magnet motor, comprising an external support frame base, a stator module and a rotor module, wherein the external support frame base includes an upper frame, a lower frame and two side frames, and the upper frame has an upper through hole formed at a position near a center position, and an upper slot is formed at the top of the upper through hole, and a bearing is installed in the upper slot, and the lower frame also has a lower through hole formed at a position near the center position, and a lower slot is formed at the top of the lower through hole, and a bearing is installed in the lower slot. The stator module includes an elastic metal plate cantilever arm and a permanent magnet stator, wherein the elastic metal plate cantilever arm is a SUS304 stainless steel plate, and the permanent magnet stator is an N45H (NdFeB) permanent magnet, and the permanent magnet stator has an upper half which is an N pole and a lower half which is a S pole, or an upper half which is a S pole and a lower half which is an N pole, and the permanent magnet stator is installed at an end of the elastic metal plate cantilever arm. The rotor module includes a rotating shaft, a double arc shaped rotating arms type support frame, and at least two thin ring permanent magnets, wherein a left bracket is installed onto the left side of the double arc shaped rotating arms type support frame, and a right bracket is installed onto the right side of the double arc shaped rotating arms type support frame, and a center hole is formed at the center of the double arc shaped rotating arms type support frame, and the thin ring permanent magnet is an N45H (NdFeB) permanent magnet, and the thin ring permanent magnet has an upper half which is a S pole and a lower half which is an N pole, or an upper half which is an N pole and a lower half which is a S pole, and the two thin ring permanent magnets are installed to the left and right brackets respectively, and installed with an opposite polarity with respect to each other, and an end of the rotating shaft is passed and fixed into the center hole of the double arc shaped rotating arms type support frame, and an end of the elastic metal plate cantilever arm of the stator module without the permanent magnet stator is fixed to the side frame on a side of the external support frame base, and the elastic metal plate cantilever arm is in form of a cantilever with respect to the external support frame base, and an end of the elastic metal plate cantilever installed at the permanent magnet stator is configured to be corresponsive to the top of the upper through hole formed at the upper frame of the external support frame base, and the rotating shaft of the rotor module is pivotally installed into the upper and lower through holes of the upper and lower frames of the external support frame base, and the rotating arms type permanent magnet motor is actuated by the action of magnetic forces of the permanent magnet stator of the stator module and the thin ring permanent magnet of the rotor module. Since the thin ring permanent magnets of the double arc shaped rotating arms type support frame are installed with opposite polarities with each other, therefore the thin ring permanent magnet of the rotor module produces magnetic repulsion and attraction with respect to the permanent magnet stator of the stator module while the elastic metal plate cantilever arm of the stator module is being swung elastically to maintain the rotation and operation of the rotating arms type support frame mounted onto a rotating shaft and drive a motor to rotate stably and regularly by a torque produced by a magnetic force. Without using any external power supply and fuel, the motor saves electricity and power sources.

### BRIEF DESCRIPTION OF THE DRAWINGS

FIG. 1 is a perspective view of the present invention;

FIG. 2 is an exploded view of the present invention;

FIG. 3 is a cross-sectional side view of the present invention;

FIG. 4 is a top view of a double arc shaped rotating arms type support frame of the present invention;

FIG. 5 is a schematic view of the installation of a permanent magnet stator of a stator module and a thin ring permanent magnet of a rotor module in accordance with the present invention;

FIG. 6 is a graph of the rotation speed of a rotating arms type permanent magnet motor versus the distance c between a permanent magnet stator of a stator module and an upper frame of an external support frame base in accordance with the present invention;

FIG. 7 is a graph of the rotation speed of a rotating arms type permanent magnet motor versus the distance d between an edge of a thin ring permanent magnet of a right bracket installed at a double arc shaped rotating arms type support frame of a rotor module and a permanent magnet stator of a stator module in accordance with the present invention;

FIG. 8 is a schematic view of the operation of a rotating arms type permanent magnet motor of the present invention; and

FIG. 9 is a schematic view of upper and lower slots of upper and lower through holes of upper and lower frames having a bearing installed therein in accordance with a preferred embodiment of the present invention.

### DESCRIPTION OF THE PREFERRED EMBODIMENTS

To make it easier for our examiner to understand the structure, technical characteristics and other objectives of the invention, we use an exemplary embodiment together with the attached drawings for the detailed description of the invention. The exemplary embodiment is illustrated in referenced figures of the drawings. It is intended that the embodiment and figures disclosed herein are to be considered illustrative rather than restrictive.

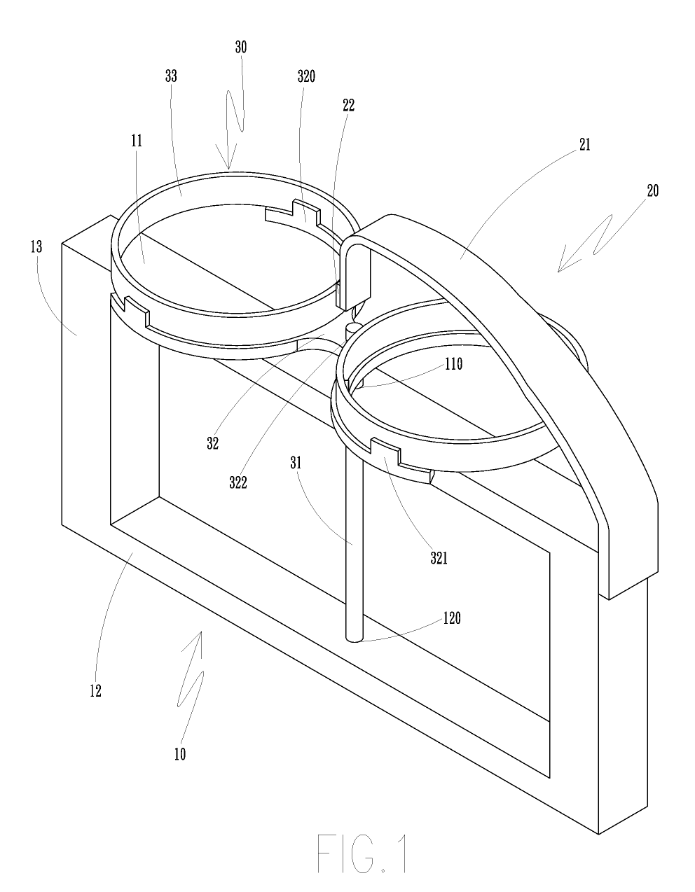

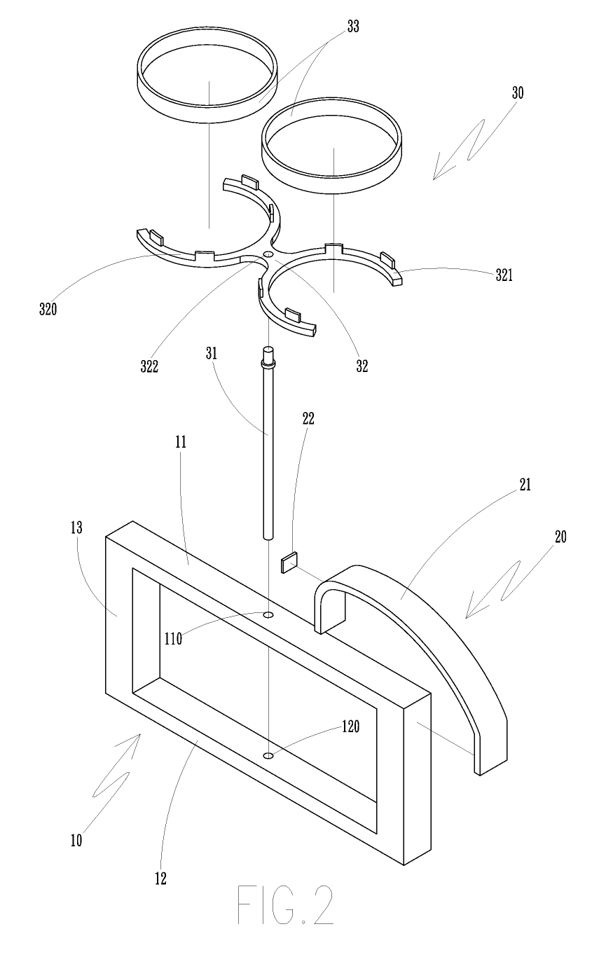

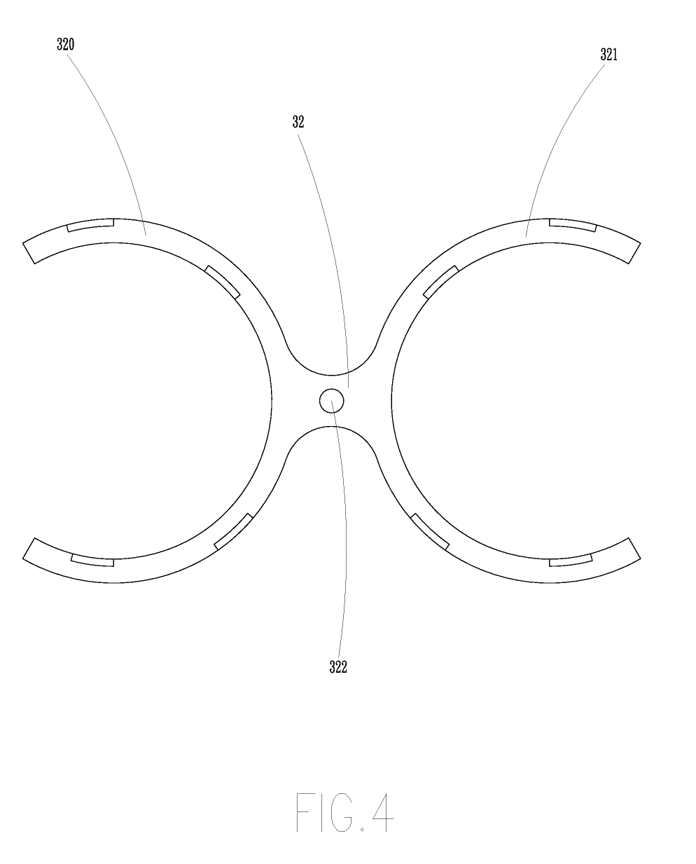

With reference to FIGS. 1 to 5 for a perspective view, an exploded view, and a cross-sectional side view of a rotating arms type permanent magnet motor, and a top view of a double arc shaped rotating arms type support frame and a schematic view of the installation of a permanent magnet stator of a stator module and a thin ring permanent magnet of a rotor module in accordance with the present invention respectively, the rotating arms type permanent magnet motor comprises an external support frame base 10 a stator module 20, and a rotor module 30.

The external support frame base 10 includes an upper frame 11, a lower frame 12 and two side frames 13, and the upper frame 11 has an upper through hole 110 formed at a position near a center position, and the lower frame 12 has a lower through hole 120 formed at a position near the center position.

The stator module 20 includes an elastic metal plate cantilever arm 21 and a permanent magnet stator 22, wherein the elastic metal plate cantilever arm 21 is a SUS304 stainless steel plate, and the permanent magnet stator 22 is an N45H (NdFeB) permanent magnet, and the permanent magnet stator 22 has an upper half which is an N pole and a lower half which is a S pole, or an upper half which is a S pole and a lower half which is an N pole (not shown in the figures), and the permanent magnet stator 22 is fixed to an end of the elastic metal plate cantilever arm 21, and an end of elastic metal plate cantilever arm 21 without the permanent magnet stator 22 is fixed to the side frame 13 on a side of the external support frame base 10, and the elastic metal plate cantilever arm 21 is in form of a cantilever with respect to the external support frame base 10, and the permanent magnet stator 22 installed at an end of the elastic metal plate cantilever arm 21 is configured to be corresponsive to the top of the upper through hole 110 of the upper frame 11 of the external support frame base 10.

The rotor module 30 includes a rotating shaft 31, a double arc shaped rotating arms type support frame 32, and at least two thin ring permanent magnets 33, wherein a left bracket 320 is installed onto the left side of the double arc shaped rotating arms type support frame 32, and a right bracket 321 is installed onto the right side of the double arc shaped rotating arms type support frame 32, and a center hole 322 is formed at the center of the double arc shaped rotating arms type support frame 32, and the thin ring permanent magnet 33 is an N45H (NdFeB) permanent magnet, and the thin ring permanent magnet 33 has an upper half which is a S pole and a lower half which is an N pole, or an upper half which is an N pole and a lower half which is a S pole (not shown in the figures), and the two thin ring permanent magnets 33 are installed to the left and right brackets 320, 321 respectively and with opposite polarities with respect to each other, and an end of the rotating shaft 31 is passed and fixed into the center hole 322 of the double arc shaped rotating arms type support frame 32, and the rotating shaft 31 is pivotally installed into the upper and lower through holes 110, 120 of the upper and lower frames 11, 12 of the external support frame base 10.

With the aforementioned structure and assembly, the rotating arms type permanent magnet motor of the present invention is achieved.

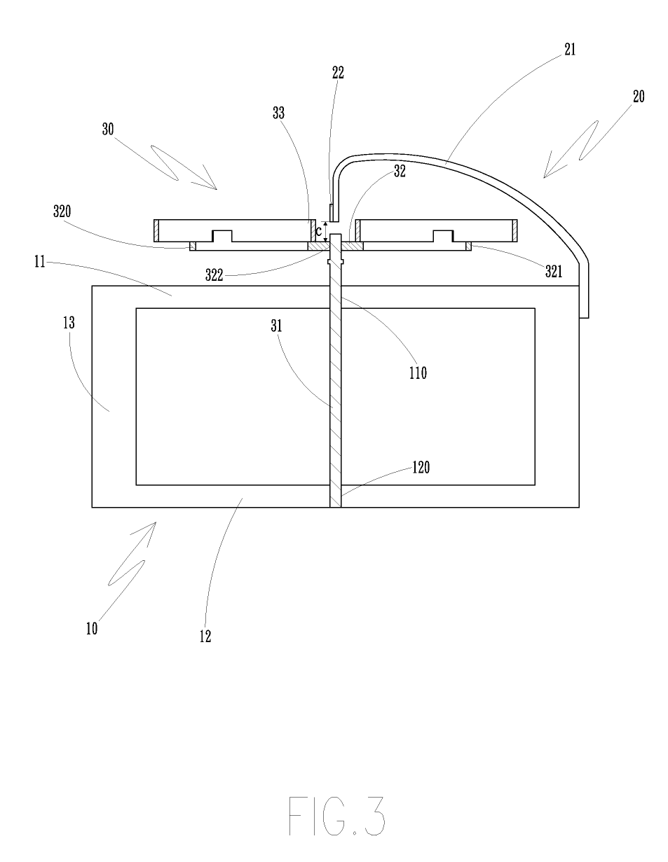

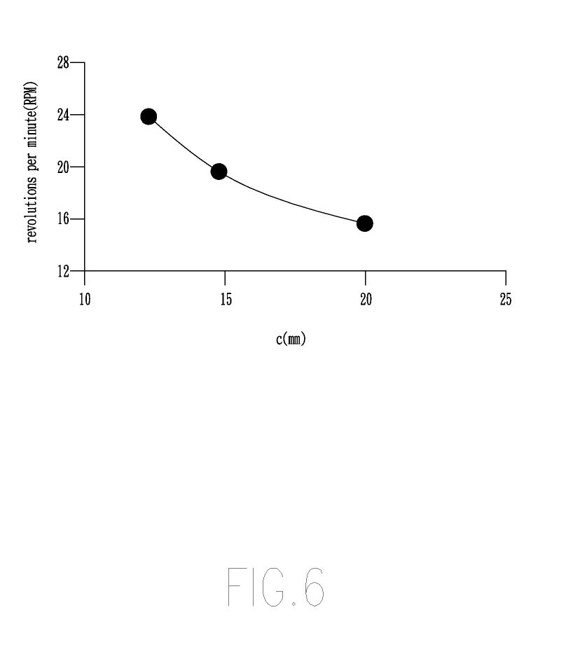

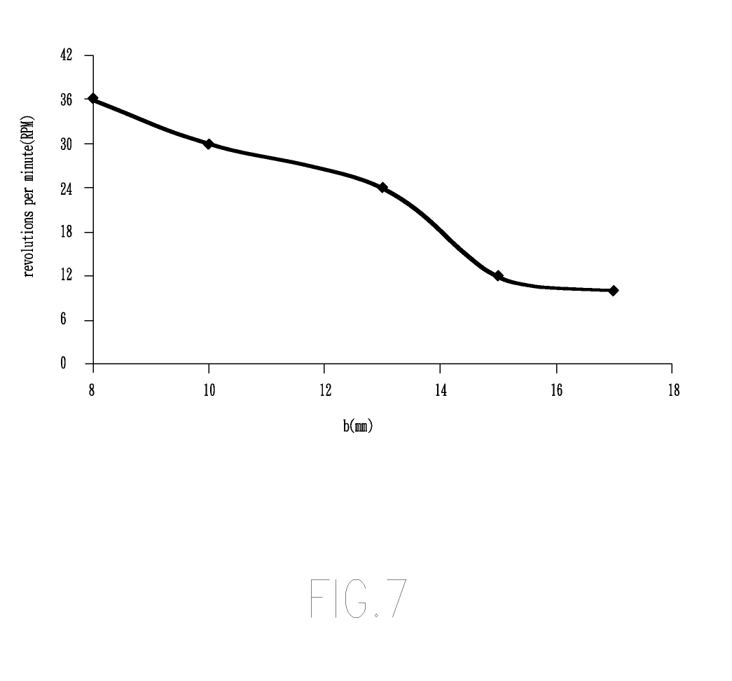

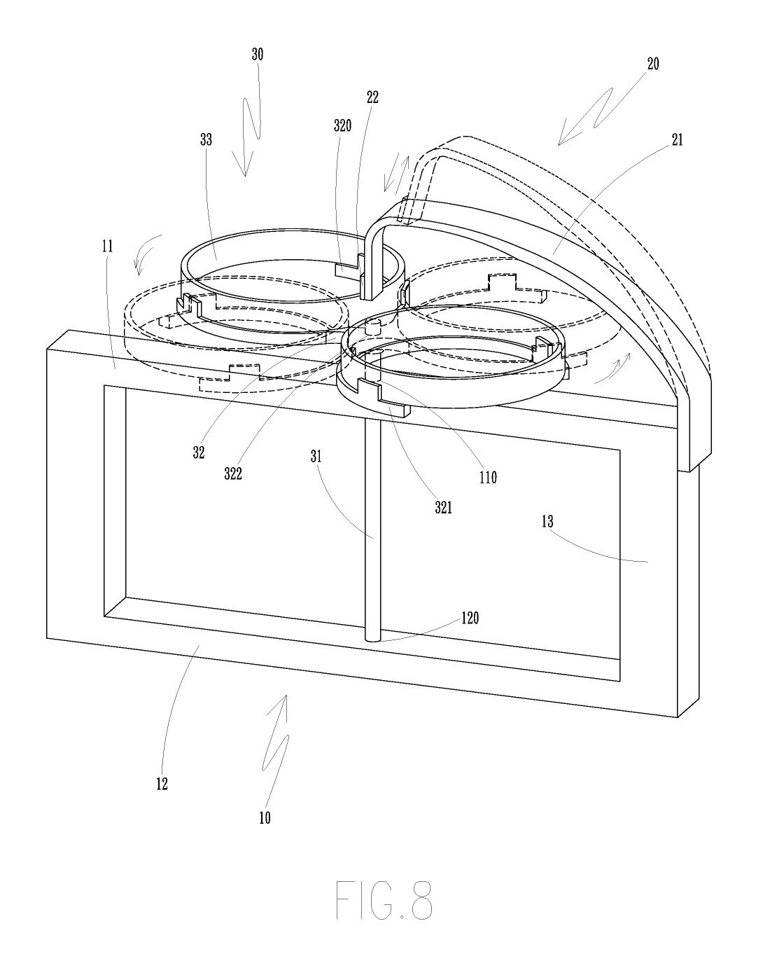

With reference to FIGS. 3 to 8 for a cross-sectional side view of a rotating arms type permanent magnet motor of the present invention, a top view of a double arc shaped rotating arms type support frame, a schematic view of the installation of a permanent magnet stator 22 of a stator module 20 and a thin ring permanent magnet 33 of a rotor module 30 in accordance with the present invention, a graph of the rotation speed of a rotating arms type permanent magnet motor versus the distance b between a permanent magnet stator 22 of a stator module 20 and an upper frame 11 of an external support frame base 10 in accordance with the present invention, a graph of the rotation speed of a rotating arms type permanent magnet motor versus the distance d between an edge of a thin ring permanent magnet 33 of a right bracket installed at a double arc shaped rotating arms type support frame of a rotor module and a permanent magnet stator of a stator module in accordance with the present invention, and a schematic view of the operation of a rotating arms type permanent magnet motor of the present invention respectively, an end of the elastic metal plate cantilever arm 21 of the stator module 20 without the permanent magnet stator 22 is fixed to the side frame 13 on a side of the external support frame base 10, and the elastic metal plate cantilever arm 21 is in form of a cantilever with respect to the external support frame base 10, and an end of the elastic metal plate cantilever arm 21 fixed to the permanent magnet stator 22 is configured to be corresponsive to the top of the upper through hole 110 of the upper frame 11 of the external support frame base 10, and the rotating shaft 31 of the rotor module 30 is pivotally installed to the upper and lower through holes 110, 120 of the upper and lower frames 11, 12 of the external support frame base 10, and the motor is actuated by the action of magnetic forces of the permanent magnet stator 22 of the stator module 20 and the thin ring permanent magnet 33 of a rotor module 30. Since the thin ring permanent magnet 33 installed at the double arc shaped rotating arms type support frame 32 is not installed with the same polarity, therefore the thin ring permanent magnet 33 of the rotor module 30 produces magnetic repulsion and attraction with respect to the permanent magnet stator 22 of the stator module 20, while the elastic metal plate cantilever arm 21 of the stator module 20 is being swung elastically to maintain the rotation and operation of the rotating arms type support frame 32 of the rotating shaft 31. In addition, the inventor of the present invention successfully implements the rotation by using the parameters a=8 mm, b=13 mm, and c=12˜20 mm and obtains a result as indicated by the graph of the rotation speed of the rotating arms type permanent magnet motor rotation speed versus the distance c between the permanent magnet stator 22 of the stator module 20 and the upper frame 11 of the external support frame base 10 as shown in FIG. 6 (wherein a is the distance between an edge of the thin ring permanent magnet of the left bracket installed to the double arc shaped rotating arms type support frame of the rotor module and the permanent magnet stator of the stator module; b is the distance between an edge of the thin ring permanent magnet of the right bracket installed to the double arc shaped rotating arms type support frame of the rotor module and the permanent magnet stator of the stator module; and c is the distance between the permanent magnet stator of the stator module and the upper frame of the external support frame base). The rotation speed of the rotating arms type permanent magnet motor increases with a decreased value of c. If the permanent magnet stator 22 is situated at a position c=12 mm, the motor rotation speed will be 24 rpm; and the values a=8 mm, b=8˜17 mm, and c=12 mm are used for implementing the rotation and obtain a graph of the rotation speed of the rotating arms type permanent magnet motor versus the distance b as shown in FIG. 7, and the rotation speed of the rotating arms type permanent magnet motor also increases with a decreased value of b. If the distance a is equal to the distance b (distance a=b=8 mm) then the rotation speed of the rotating arms type permanent magnet motor will be 36 rpm, and thus providing a faster rotation of the speed motor. Since the rotating arms type permanent magnet motor can produce rotations by the magnetic force of its magnetism, it is very essential to the novel green design for the mechanical motors. The magnetic force produces a torque for the stable and regular rotation of the motor. Without using any external power supply or fuel, the present invention can save electricity and power sources. In addition, the motor of the present invention can be applied extensively in different areas, and the invention provides high operation performance and diversified functions.

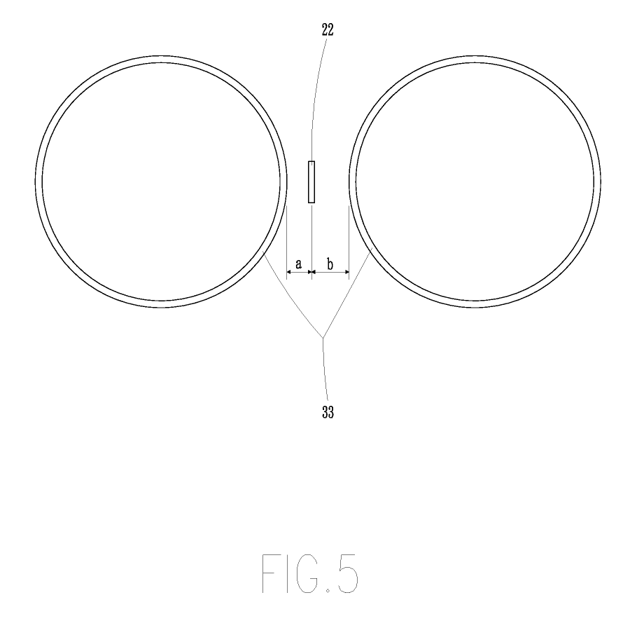

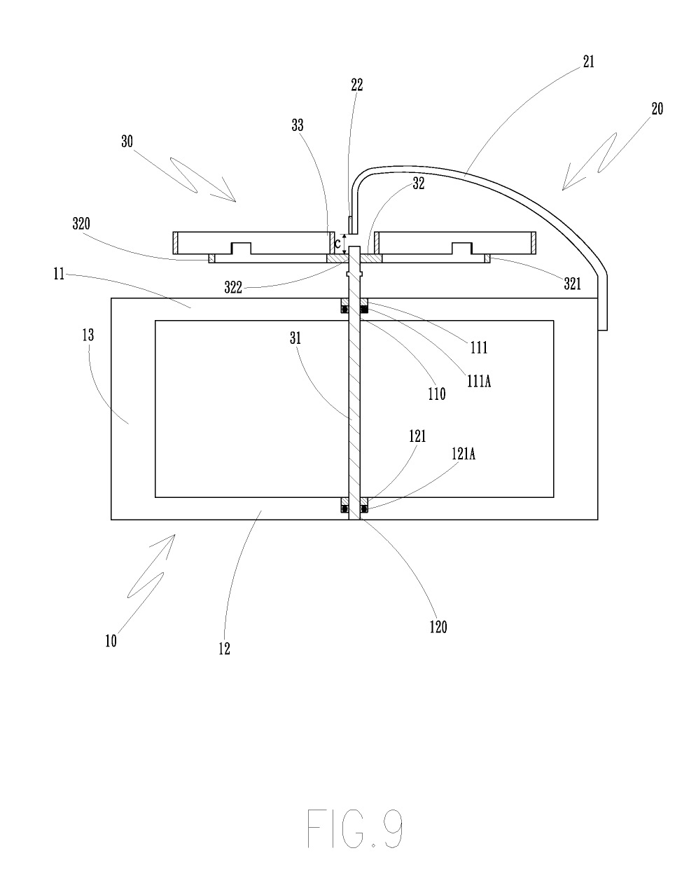

With reference to FIG. 9 for a schematic view of each of the upper and lower slots of upper and lower through holes of upper and lower frames having a bearing installed therein in accordance with a preferred embodiment of the present invention, the overall structure is substantially the same as the structure as shown in FIGS. 1 and 5, except that the upper and lower through holes 110, 120 of the upper and lower frames 11, 12 of the external support frame base 10 have an upper slot 111 and a lower slot 121 respectively, and the upper slot 111 includes a bearing 111A installed therein, and the lower slot 121 includes a bearing 121A installed therein, and the installation of the bearings 111A, 121A makes the operation of the pivotally installed rotor module 30 more smoothly to improve the practical applications of the invention.

What is claimed is:

1. A rotating arms type permanent magnet motor, comprising:
an external support frame base, including an upper frame, a lower frame and two side frames, and the upper frame having an upper through hole formed at a position near a center position, and the lower frame having a lower through hole formed at a position near the center position;
a stator module, including an elastic metal plate cantilever arm and a permanent magnet stator, and the permanent magnet stator being installed at an end of the elastic metal plate cantilever arm, and an end of the elastic metal plate cantilever arm without the permanent magnet stator being fixed to the side frame on a side of the external support frame base, and the elastic metal plate cantilever arm being in form of a cantilever with respect to the external support frame base, and an end of the elastic metal plate cantilever being installed at the permanent magnet stator being configured to be corresponsive to the top of the upper through hole formed at the upper frame of the external support frame base; and
a rotor module, including a rotating shaft, a double arc shaped rotating arms type support frame, at least two thin ring permanent magnets, a left bracket fixed to the left side of the double arc shaped rotating arms type support frame, a right bracket fixed to the right side of the double arc shaped rotating arms type support frame, and a center hole formed at the center of the double arc shaped rotating arms type support frame, and the two thin ring permanent magnets being fixed to the left and right brackets respectively, and the two thin ring permanent magnets being installed with the magnetic poles opposite to each other, and an end of the rotating shaft being passed and fixed into the center hole of the double arc shaped rotating arms type support frame, and the rotating shaft being pivotally installed to the upper and lower through holes of the upper and lower frames of the external support frame base.

2. The rotating arms type permanent magnet motor of claim 1, wherein each of the upper and lower slots of the upper and lower through holes of the upper and lower frames of the external support frame base includes a bearing installed therein.

3. The rotating arms type permanent magnet motor of claim 1, wherein the elastic metal plate cantilever arm of the stator module is a SUS304 stainless steel plate.

4. The rotating arms type permanent magnet motor of claim 1, wherein the permanent magnet stator of the stator module is a N45H (NdFeB) permanent magnet.

5. The rotating arms type permanent magnet motor of claim 1, wherein the permanent magnet stator of the stator module has an upper half which is an N pole while a lower half which is a S pole, or an upper half which is a S pole while a lower half which is an N pole, and the thin ring permanent magnet of the rotor module has an upper half which is a S pole and a lower half which is an N pole, or an upper half which is a N pole and a lower half which is a S pole.

6. The rotating arms type permanent magnet motor of claim 1, wherein the distance of the permanent magnet stator of the stator module apart from the upper frame of the external support frame base is c, and the rotating arms type permanent magnet motor has a rotation speed increasing with a decreasing value of c.
